(19) United States
(12) Patent Application Publication
(10) Pub. No.: US 2005/0198906 A1
(43) Pub. Date: Sep. 15, 2005

(54) Glass run structure for vehicle

(75) Inventors: Yasuyuki Fujita, Hiroshima (JP); Syuuji Raisu, Hiroshima (JP)

Correspondence Address: FRISHAUF, HOLTZ, GOODMAN & CHICK, PC, 220 5TH AVE FL 16, NEW YORK, NY, 10001-7708, US

(73) Assignee: Nishikawa Rubber Co., Ltd., Hiroshima-shi (JP)

(21) Appl. No.: 11/011,284

(22) Filed: Dec. 13, 2004

(30) Foreign Application Priority Data
Mar. 11, 2004 (JP) 2004-068498
Jun. 30, 2004 (JP) 2004-193592

(51) Int. Cl. E06B 7/16

(52) U.S. Cl. 49/428; 49/414

(57) ABSTRACT

A glass run structure for a vehicle door, in which a glass run is formed from a glass run body with a substantially U-shaped cross section, as well as a bottom and sidewalls provided on both sides of the bottom; and a hollow inner lip and an outer lip extending inward from an open end of the glass run body. The sidewall is formed from a steel member with an L-shaped cross section. The glass run is mounted to a sash provided in a window frame of a door panel above a belt line; while in a lower end portion below the belt line, the glass run is fixed by welding to an attachment portion of a bracket that is held by a bolt to the door panel.

### BACKGROUND OF THE INVENTION

1. Field of the Invention

The present invention relates to a glass run structure provided in a vehicle door, which guides a window glass and seals a clearance with the window glass.

2. Related Art

A glass run structure is generally provided in a vehicle door for guiding a rim of a window glass 32 and sealing purposes as shown in FIG. 9. The glass run structure, as shown in FIGS. 9 and 10, includes a sash 33 provided in a window frame of the door above a belt line B.L., a lower sash 34 extending into a door panel below the belt line B.L., and a glass run 35 mounted in the sash 33 and the lower sash 34. The glass run 35 has a substantially U-shaped cross section, and is formed of resin or rubber such as EPDM. Provided at an open end of the glass run 35 are an outer lip 36 and an inner lip 37, which elastically contact and seal the window glass 32.

In such a conventional glass run structure, the lower sash 34 is formed separate from the sash 33 and mounted in a door panel 31. Thus as shown in FIG. 11, contact between both sashes may be misaligned due to fitting variations. If the sash 33 and the lower sash 34 are misaligned due to fitting variations such as shown in FIG. 11, the inner lip 37 of the glass run 35 attached to the sash 33 as shown in FIG. 10 is strongly pressed onto the window glass 32. This leads to problems such as a so-called squealing noise caused by the window glass 32 sliding against the inner lip 37 when raised or lowered, and wear of the inner lip 37.

Furthermore, the conventional glass run structure tends to become complicated, because the lower sash 34 is mounted to the door panel 31 by fixing the top and bottom of the lower sash 34 to the door panel 31 with brackets 38.

A known glass run structure that eliminates the need for a lower sash is described in Japanese Patent Laid-Open Publication No. 5-116534. As shown in FIG. 12, the glass run structure is formed with the following: a core metal 41 having a substantially U-shaped cross section, an outer lip 42 and an inner lip 43 provided at an open end portion of the core metal 41, a glass run 45 formed with a lip 44 provided on an interior-side of the core metal 41, and a bracket 46 fixed to the door panel and to which the core metal 41 is welded. According to such a glass run structure, the glass run 45 can be mounted to the door panel without being affected by fitting variations of the lower sash as in related art, because the lower sash is not used. Consequently, the squealing noise and inner lip wear due to strong compression of the inner lip that is caused by lower sash fitting variations can be prevented. Eliminating the lower sash includes additional advantages such as a simpler structure, and easier installation operation through elimination of the operation for attaching the glass run to the lower sash.

However, mounting the core metal 41 to the door panel requires bending it to align with the curved surface of the window glass 32. Being made of steel, it is not easy to bend the core metal 41.

It is an object of the present invention to provide a glass run structure, for which the installation operation and curving to match a curved surface of a window glass are simple and also reduce the weight of the structure.

### SUMMARY OF THE INVENTION

A glass run structure for a vehicle door according to the present invention has a glass run having a glass run body forming a substantially U-shaped cross section with a bottom and a sidewall on both sides of the bottom, and an inner lip and an outer lip respectively disposed protruding from an open end of the body toward an interior-side so as to elastically contact a window glass. The glass run body is formed with a portion among the bottom and both sidewalls made of metal, preferably steel, and other portions made of resin or rubber such as EPDM. The glass run is mounted to a sash in a door window frame above a belt line; while below the belt line, a metal portion is attached by attachment means such as welding or a screw to a bracket fixed to a door panel.

According to the glass run structure of the present invention, effects such as the following are obtained. A simplified glass run structure configuration with reduced weight can be achieved because a lower sash is unnecessary. Unlike a conventional glass run structure provided with a lower sash, operations to mount the lower sash and attach the glass run to the lower sash become unnecessary, thereby simplifying the operation to mount the glass run in the door panel. It is also possible to inhibit a squealing noise and wear of the inner lip, which are generated by the inner lip strongly pressing against the window glass due to fitting variations when mounting the lower sash to the door panel. Compared to a glass run body made entirely of metal, the glass run body can be more easily bent to match a curved surface of the window glass, even though a portion of the glass run body may be made of metal.

In another preferred embodiment of the present invention, the glass run body is made of resin or rubber such as EPDM with a metal core embedded in a portion of the glass run body. The metal core has a protruding portion protruding outward from the glass run body, which is attached by attachment means such as welding or a screw to a bracket fixed to a door panel.

Since the protruding portion of the metal core protruding outward from the glass run body is attached to a bracket in the present invention, the glass run can be more easily mounted, as compared to amounting operation by a screw or welding performed in a narrow space of the glass run body under the presence of a lip.

In another preferred embodiment of the present invention, the glass run body is made of resin or rubber with a high rigidity, and the inner lip and outer lip are formed from flexible material.

According to the present invention, the glass run body is resistant to deformation, resulting in stable support of the window glass similar to a conventional glass run. Furthermore, the inner lip and outer lip formed from flexible material ensure elastic contact with the window and a secure seal.

The metal portion or the metal core that form a portion of the glass run body in the above glass run structure preferably are provided on an interior-side sidewall among opposing sidewalls and on a portion of the bottom connecting both sidewalls.

According to the glass run structure of the present invention, maintaining the shape of the bottom and one of the sidewalls stabilizes and supports the window glass. Furthermore, bending of the glass run also becomes easier, if bending is required to match the curved surface of the window glass.

Similar to a conventional extruded glass run, the above glass run can be obtained by extruding the metal portion or metal core forming a portion of the glass run body at the same time as the glass run body. However, in order to secure the integration of the metal portion and another resin or rubber portion, a preferred structure provides an adhesive layer on the surface of a desired area of the metal portion to adhere both portions together. Alternatively, a hole or uneven area is provided in the metal portion, by which the metal portion and the resin or rubber portion are combined. In the latter case where there is no adhesion, the metal portion and resin or rubber portion can be easily separated and reused.

The outer lip of the above glass run structure is solid, and the inner lip may also be solid, although a hollow shape is preferred. It is even more preferred for the inner lip to have a thin thickness capable of securing a large volume. A hollow shape inhibits vibration of the window glass and suppresses the generation of a rattling noise from the window glass. In addition, securing a thin thickness and large volume lead to sufficient generation of a reaction force from the inner lip when in elastic contact with the window glass.

Even when forming a hollow inner lip, the inner lip of the glass run attached to the sash in a top rim of the window frame may also be formed in a solid tongue-piece-like shape, because little force is required to support the window. To mold a corner portion in this case, it is necessary to assemble the hollow inner lip of the extruded glass run to a die in a crushed state. At this time, it is preferable that a thin bending portion is provided in the hollow lip such that the hollow lip is always crushed to a fixed shape.

It is also preferable for the inner lip to be provided with a projecting portion on the window-glass-side that is surely contacting the window glass to ensure a stable sealing effect.

The bracket of the above glass run structure preferably has an attachment portion extending along the metal portion or the metal core. Having the attachment portion next to the metal portion or the metal core makes the glass run more resistant to deformation, thus ensuring stable support of the window glass.

The above glass run structure of the present invention can be used in a center pillar and front pillar of a front door, or a center pillar and rear pillar of a rear door; the door may also be a sash door type or a door panel type.

Other features and effects of the present invention will be more clearly understood in the following detailed description of the embodiments by those skilled in the art. It must be, however, noted that the technical scope of the present invention is not limited to the embodiments and the accompanying drawings alone.

### BRIEF DESCRIPTION OF THE DRAWINGS

FIG. 1 is a front view of a glass run structure according to the present invention provided in a vehicle door;

FIG. 2 is a cross-sectional view taken along a line 2-2 in FIG. 1;

FIG. 3 is a cross-sectional view taken along a line 3-3 in FIG. 1;

FIG. 4 is a cross-sectional view taken along a line 4-4 in FIG. 1;

FIG. 5 is a cross-sectional view of another embodiment of a glass run according to the present invention:

FIG. 6 is a cross-sectional view of another embodiment of the glass run structure shown in FIG. 4;

FIG. 7 is a cross-sectional view of another embodiment of the glass run structure shown in FIG. 4;

FIG. 8 is a cross-sectional view of another embodiment of the glass run structure shown in FIG. 4;

FIG. 9 is a front view of a conventional glass run structure provided in a vehicle door;

FIG. 10 is a cross-sectional drawing taken along a line 10-10 in FIG. 9;

FIG. 11 is a drawing showing misalignment of a sash and a lower sash; and

FIG. 12 is a cross-sectional drawing showing another example of a conventional glass run structure.

### DESCRIPTION OF THE PREFERRED EMBODIMENTS

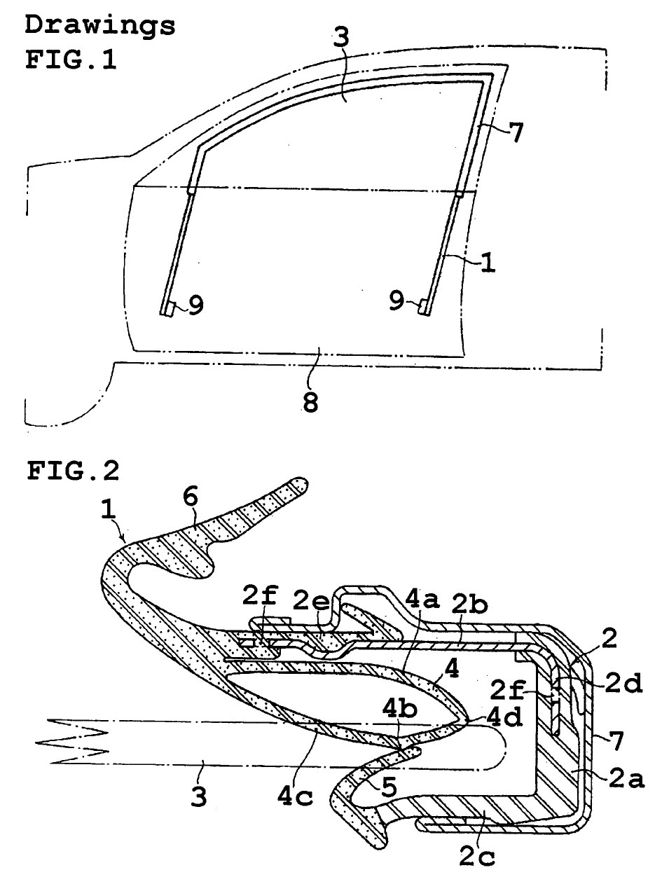

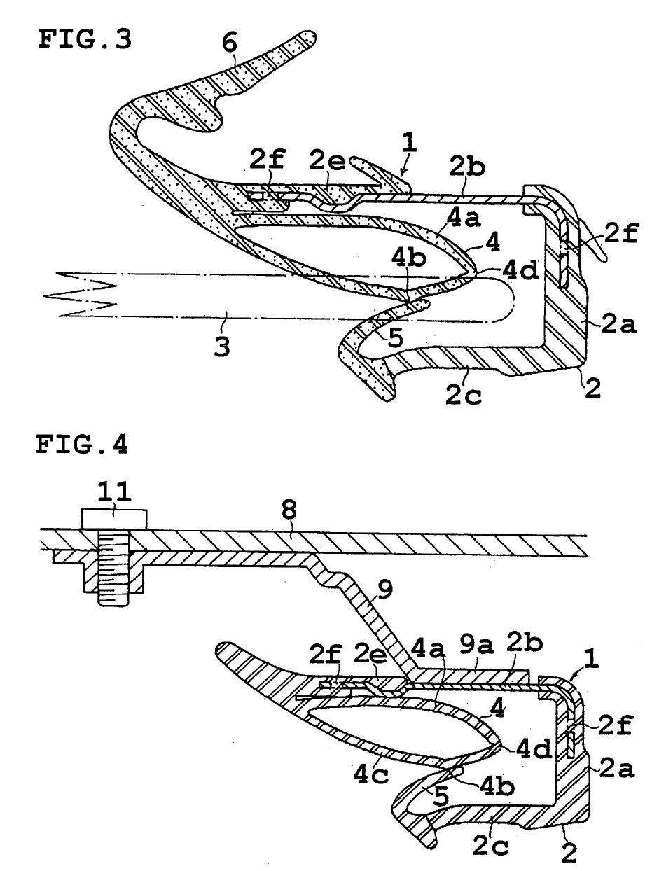

FIGS. 1 to 4 show a glass run structure according to the present invention. A glass run 1 is formed from a glass run body 2 with a substantially U-shaped cross section, a hollow inner lip 4, an outer lip 5, and a cover lip 6. The glass run body 2 is formed from a bottom 2a and sidewalls 2b and 2c provided on both sides of the bottom. The inner lip 4 extends inward toward the bottom 2a from an end of the sidewall 2b that forms an open end of the glass run body 2. Elastically contacting a window glass 3, the inner lip 4 also seals a clearance with the window glass 3. Likewise, the outer lip 5 extends inward toward the bottom 2a from an end of the sidewall 2c that forms an open end of the glass run body 2, elastically contacts the window glass 3, and seals a clearance with the window glass 3. The cover lip 6 faces away from the end of the sidewall 2b and extends opposite the inner lip 4 to cover an end portion of interior material (not shown). In addition, the inner lip 4 has a protrusion 4b on a wall portion 4c provided on the window-glass-side. One side of the inner lip 4 has a thin inflected portion 4d at a peak forming a boundary between the wall portion 4c and a wall portion 4a linearly extending along the sidewall 2b. The bottom 2a and sidewall 2c of the glass run body 2 are formed of a resin with high rigidity; the sidewall 2b has a cross section with an L-shape and is formed from a steel member. A bent portion 2d folded inward of the steel member is received in the bottom 2a. Furthermore, the end side of sidewall 2b is received in a wall portion 2e formed integral with the inner lip 4 and the cover lip 6, which are formed of flexible resin. A hole 2f is formed in the steel sidewall 2b at a portion received in the resin.

As shown in FIGS. 1 and 2, the glass run 1 is mounted to a sash 7 provided in a window frame of a door panel 8 above a belt line B.L. In a lower end portion below the belt line B.L., the steel sidewall 2b of the glass run body 2 is fixed by welding to an attachment portion 9a of a bracket 9 that is held by a bolt 11 to the door panel 8, as shown in FIG. 4. It should be noted that a portion of the resin wall portion 2e is cut and removed as shown in FIG. 4, so as not to interfere with the welding of the sidewall 2b of the glass run body 2 to the attachment portion 9a of the bracket 9.

In the glass run structure of the present embodiment, effects such as the following are obtained. A portion of the glass run body 2 is made of steel and the rest is made of a resin with high rigidity, providing sufficient rigidity such that the glass run body 2 can be thus installed without providing a lower sash in the door panel 8 below the belt line B.L. as in the conventional glass run structure. Elimination of the lower sash results in a proportional simplification and weight reduction of the glass run structure. Operations to mount the lower sash in the door panel 8 and attach the glass run to the lower sash become unnecessary, thereby simplifying the operation to mount the glass run 1 in the door panel 8. It is also possible to inhibit a squealing noise and wear of the inner lip, which are generated by the inner lip strongly pressing against the window glass 3 in the conventional glass run structure, due to fitting variations when mounting the lower sash to the door panel. Compared to a glass run body made entirely of metal, the glass run body 2 can be more easily bent to match a curved surface of the curved window glass 3, because even though a portion of the glass run body 2 is made of steel, the rest is made of resin. Once the window glass 3 elastically contacts the inner lip 4, the inner lip 4 immediately makes elastic contact with the sidewall 2b as well, because the inner lip 4 is a thin hollow shape that also extends along the sidewall 2b. Using the reaction force from the sidewall 2b, the inner lip 4 thus acts together with the outer lip 5 to securely hold the window glass 3. Consequently, vibration of the window glass 3 is inhibited, thereby suppressing looseness.

In the glass run structure described above, the sidewall 2b of the glass run body 2 is made of steel, but the sidewall 2c may be made of steel instead of the sidewall 2b; and a steel bottom 2a may also be used. However, the sash and the window glass are both inclined toward the vehicle-interior-side in accordance with narrowing of the vehicle width towards the top of the vehicle. Thus, forming the sidewall 2b on the vehicle-interior-side from steel to increase the strength of the sidewall 2b is preferred, in order to securely hold the window glass.

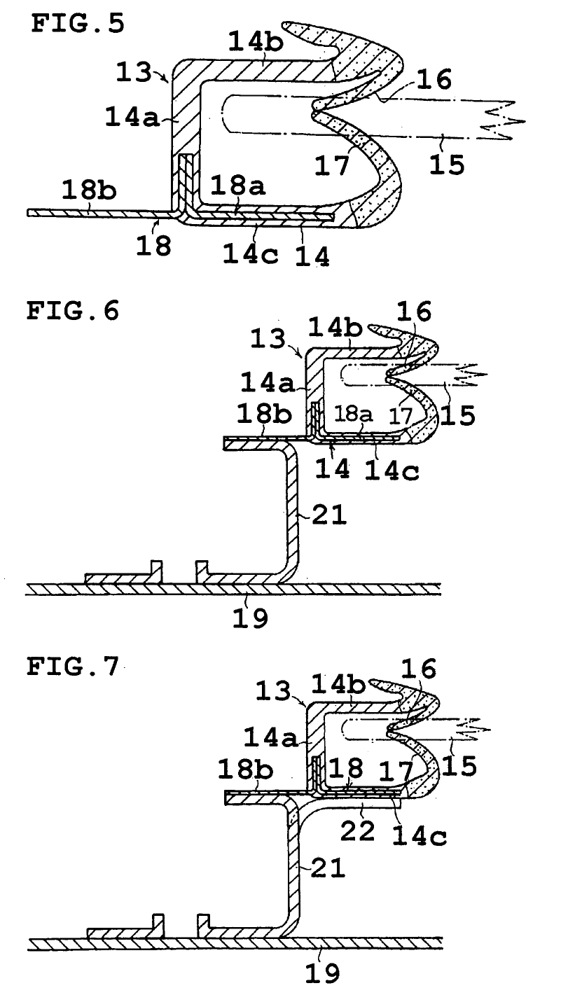

FIG. 5 shows another embodiment of the glass run. A glass run 13 is formed from a glass run body 14 with a U-shaped cross section, an inner lip 16, an outer lip 17, and a metal core 18. The glass run body 14 is made of rubber or resin with high rigidity, and formed from a bottom 14a and sidewalls 14b and 14c provided on both sides of the bottom. The inner lip 16 is made of flexible rubber or resin, and extends inward toward the bottom 14a from an end of the sidewall 14b that forms an open end of the glass run body 14. Elastically contacting a window glass 15, the inner lip 16 also seals a clearance with the window glass 15. Likewise, the outer lip 17 is made of flexible rubber or resin, and extends inward toward the bottom 14a from an end of the sidewall 14c that forms an open end of the glass run body 14, elastically contacts the window glass 15, and seals a clearance with the window glass 15. The metal core 18 has a form in which the shorter sides of a pair of members 18a with an L-shaped cross section are disposed back to back. An L-shaped member 18a of the metal core 18 is embedded in a portion of the sidewall 14c; the shorter side of the other L-shaped member 18a is embedded in a portion of the bottom 14a; and the longer side of the other L-shaped member 18a protrudes from the sidewall 14c to form a fixing portion 18b for a bracket described later.

The glass run 13 is configured such that the fixing portion 18b is fixed by welding to a bracket 21 that is held by a bolt (not shown) to a door panel 19, as shown in FIG. 6.

In the glass run structure shown in FIG. 7, a support member 22 is integrally formed with the bracket 21 along the sidewall 14c of the glass run body 14, such that the glass run 13 is supported by the support member 22.

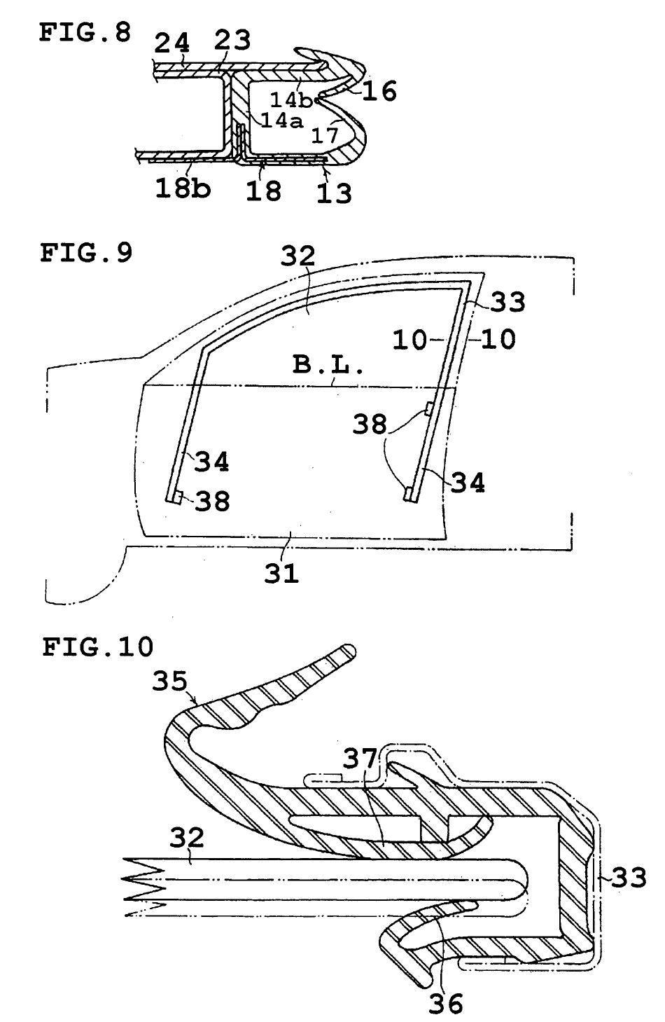

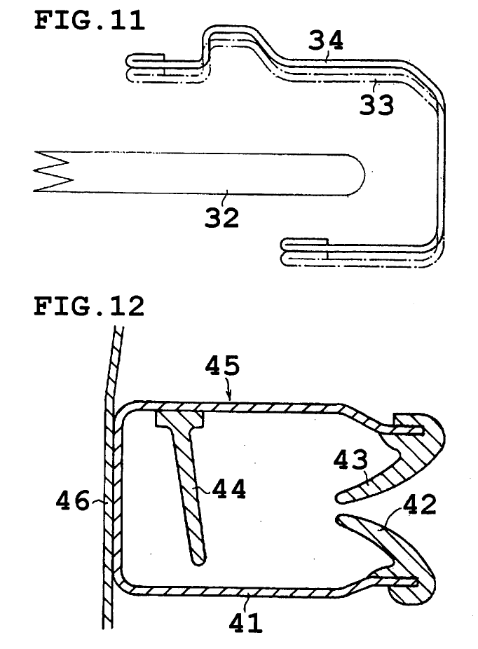

In the glass run structure shown in FIG. 8, the glass run 13 shown in FIG. 5 is mounted to a window frame 23 of the door panel 19 above the belt line B.L. by a bracket 24.

1. A glass run structure for a vehicle door comprising:
a glass run comprising a glass run body forming a substantially U-shaped cross section with a bottom and a sidewall on both sides of the bottom; and
an inner lip and an outer lip respectively disposed protruding from an open end of the body toward an interior-side so as to elastically contact a window glass, wherein
the glass run body is formed with a portion among the bottom and both sidewalls made of metal, and other portions made of one of rubber and resin, and
the glass run is mounted to a sash in a door window frame above a belt line; while below the belt line, a metal portion is attached by attachment means to a bracket fixed to a door panel.

2. A glass run structure for a vehicle door comprising:
a glass run body forming a substantially U-shaped cross section with a bottom and a sidewall on both sides of the bottom; and
a glass run comprising an inner lip and an outer lip respectively disposed protruding from an open end of the body toward an interior-side so as to elastically contact a window glass, wherein
the glass run body is made of one of rubber and resin with a metal core embedded in a portion of the glass run body, and
the metal core has a protruding portion protruding from the glass run body, which is attached by attachment means to a bracket fixed to a door panel.

3. The glass run structure according to claim 1, wherein the glass run body is made of one of rubber and resin with a high rigidity, and the inner lip and outer lip are formed from flexible material.

4. The glass run structure according to claim 1, wherein the metal portion is provided on an interior-side sidewall among opposing sidewalls and on a portion of the bottom connecting both sidewalls.

5. The glass run structure according to claim 1, wherein the inner lip is hollow.

6. The glass run structure according to claim 1, wherein one of a hole and an uneven area is formed in a portion of the metal portion, the hole and the uneven area being received in one of rubber and resin.

7. The glass run structure according to claim 1, wherein the bracket has an attachment portion extending along the metal portion of the sidewall.

8. The glass run structure according to claim 2, wherein the glass run body is made of one of rubber and resin with a high rigidity, and the inner lip and outer lip are formed from flexible material.

9. The glass run structure according to claim 2, wherein the metal core is provided on an interior-side sidewall among opposing sidewalls and on a portion of the bottom connecting both sidewalls.

10. The glass run structure according to claim 2, wherein the inner lip is hollow.

11. The glass run structure according to claim 2, wherein one of a hole and an uneven area is formed in a portion of the metal core, the hole and the uneven area being received in one of rubber and resin.

12. The glass run structure according to claim 2, wherein the bracket has an attachment portion extending along the metal core embedded in the sidewall.
